(19) United States
(12) Patent Application Publication
(10) Pub. No.: US 2023/0033182 A1
(43) Pub. Date: Feb. 2, 2023

(54) Ladder

(71) Applicant: Anibal SCHURTER, Santa Cruz (CL)

(72) Inventor: Anibal SCHURTER, Santa Cruz (CL)

(21) Appl. No.: 17/864,766

(22) Filed: Jul. 14, 2022

Related U.S. Application Data
(60) Provisional application No. 63/221,705, filed on Jul. 14, 2021.

(51) Int. Cl. E06C 1/20; E06C 7/50

(52) U.S. Cl. CPC E06C 1/20; E06C 7/50

(57) ABSTRACT

A ladder that enables unwanted accidents to be avoided by means of a simplified structure and mechanism, said ladder comprising: a main structure (10) comprising stringers (11), rungs (12) and an upper platform (13); and a support leg (20) in the shape of a tube (22) pivotally connected to the upper platform (13). The upper platform comprises a top face, two side faces, a front face, and a rear face, wherein said side faces have connection means to a connector of the support leg (20). In addition, the rear face has a slot (24) whose height is less than the diameter of the tube (22).

### FIELD OF THE INVENTION

This invention has application in the field of metal ladders, in particular, those used in the agricultural industry for hand-harvesting fruits in the field, preferably made of aluminum and having three support points on the ground.

### BACKGROUND OF THE INVENTION

In the agricultural industry, the use of ladders known as “harvester” type is common. These types of ladders are usually made of aluminum and can have a height that varies between 2 and 3.5 m, which is necessary to harvest fruit trees or any other type of cultivation at height.

A particularity of the harvesting ladders is that they have at least 3 points of support against the ground, in order to try to provide stability to the ladder and safety to the person who is on it doing the harvest work. These three points of support generally correspond to the two lower ends of the beams of the main structure of the ladder, the third point of support being the end of a support leg which is usually connected to the top of the main structure. This support leg is generally in the shape of a cylindrical tube.

The junction between the support leg and the main structure of the ladder is usually a hinged joint, allowing the first to pivot relative to the second. The primary purpose of this hinged joint is to allow the angle between the main structure and the support leg to be varied in order to give the ladder the desired inclination and height. Generally, the operating angle is between 0 and 90 degrees. The second objective of the hinged joint is to reduce the volume of space occupied by the disused ladder, which is achieved by lowering the support leg against the main structure (angle 0).

It has been observed that state-of-the-art harvesting ladders have the disadvantage that the hinged joint is free, i.e., it allows oscillation ranges of more than 90 degrees. This puts the safety of the person on the ladder at serious risk, since if this angle is exceeded, for example, because the support leg loses adherence to the ground, the person could fall. Additionally, the cylindrical shape of the support leg favors the sliding of the support leg on the ground since, being inclined, the surface area of the edge of the cylinder that rests on the ground is small.

The patent literature discloses some solutions that attempt to address these problems, such as document U.S. Pat. No. 4,600,080A which proposes a tripod ladder where the support leg is connected to the main structure not only by means of the hinged joint, but also by arms that allow limiting the opening angle of the support leg. A similar solution is disclosed in document CN104265151A, which also proposes a telescopic type support leg.

Although the ladders disclosed in these documents allow preventing the opening of the support leg to undesired angles, the arms and the mechanism acting on these elements for the closing and opening of the leg, add additional weight to the ladder which is undesirable. Additionally, this type of mechanism complicates the operation of opening and closing the support leg and is subject to wear and tear, as well as the risk of cracking, for example during the season when the ladder is in disuse and stored in a folded position for a long time.

It is therefore a general objective of this invention to overcome the drawbacks discussed above by employing a ladder that makes it possible to avoid undesired accidents by means of a simplified structure and mechanism.

Another drawback observed in the state-of-the-art literature is that they provide ladders with static safety systems, i.e., which only seek to ensure the correct support of their legs or supports on the ground. However, it is known that, many times, due to ground conditions or external effects, such as sudden or unexpected movements by the user, it is impossible to avoid slipping or movement of the ladder on the ground.

It is therefore a specific objective of this invention to improve the behavior and, above all, the stability of the ladder in the face of fortuitous events, such as the unexpected slipping of the support points on the ground, thus minimizing possible falls, blows or injuries to the user.

### DESCRIPTION OF THE INVENTION

This invention consists of a ladder comprising: a main structure including stringers, rungs, and an upper platform, together with a tube-shaped support leg pivotally connected to the upper platform. The upper platform includes a top face, two side faces, a front face, and a rear face, wherein said side faces have connection means to a connector of the support leg. In addition, the rear face possesses a slot whose height is less than the diameter of the tube. By means of this configuration, especially by means of the slot on the rear face of the platform, the support leg is advantageously prevented from opening at an angle of more than 90 degrees with respect to the main structure. At the same time, it allows the leg to be able to move in a safe range that permits height adjustment and balancing of the ladder by the user.

According to one embodiment, the support leg connector is a cylinder pin that passes perpendicularly through the tube near its upper end and whose ends are connected to the upper platform by means of bolts. This configuration generates a free end in the upper part of the support leg tube, whose upper face meets the upper edge of the slot in the maximum opening position (90 degrees), thus maintaining a safe operating range that avoids the risk of accidents due to a possible slipping of the support leg on the ground.

According to one embodiment, the pin is attached to a pair of plates welded to each side of the tube, which provides resistance to the support leg in the area of union with the main structure. That is, these plates prevent buckling or oscillation of the hinged joint, making it very stable and thus preventing unexpected movement of the support leg, as well as the risk of such movement destabilizing the user with the consequent risk of falling.

According to one embodiment, the support leg has a gripping element at its lower end, which preferably has two or more points of support with the ground. Thanks to this gripping element, the risk of the support leg slipping on the surface on which it is resting, such as earth, mud, stones, or branches is advantageously reduced. Furthermore, in the event that slipping is unavoidable, the shape of the support leg is such as to reduce the opening speed of the support leg, improving stability and reducing the risk of the user suddenly losing balance in the event of loss of grip.

Therefore, the ladder of this invention provides three essential elements which, acting either separately or together, make it possible to significantly improve the stability of its structure in the working position, as well as to avoid accidents to the user standing on it, by minimizing slippage of the support leg and even providing greater stability in the face of fortuitous events of slipping on the ground.

According to one embodiment, the connection means of the main body of the ladder consist of holes through which the ends of the grip leg pin are inserted, thus obtaining a pivotable connection between the main body and the support leg.

According to one embodiment, the stringers are partially curved and positioned such that the convex faces of both beams are facing each other. This shape of the stringers advantageously provides greater structural strength to the ladder.

According to one embodiment, the stringers and rungs are channel-shaped. In addition, the stringers and rungs are joined together by means of rivets and may also be joined together by means of gussets, thus providing a firm connection.

### DESCRIPTION OF THE FIGURES

FIG. 1 illustrates a perspective view of the ladder of the invention.

FIG. 2 illustrates a front view of the ladder of the invention.

FIG. 3 illustrates a rear view of the ladder of the invention.

FIG. 4 illustrates a profile view of the ladder of the invention.

FIG. 5 illustrates a detail of the joining mechanism between the main structure and the support leg of the ladder of the invention.

FIG. 6 illustrates in detail the main elements of the support leg of the ladder of the invention.

### DETAILED DESCRIPTION OF THE INVENTION

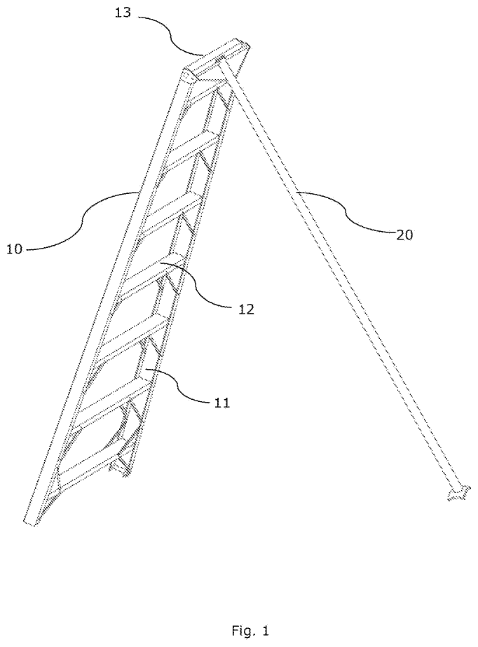

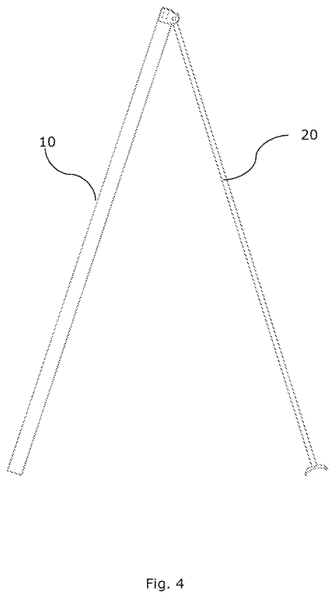

The ladder according to the embodiment observed in FIGS. 1 to 4 consists of a main structure 10 comprising stringers 11, rungs 12, and an upper platform 13, in addition to a tube-shaped support leg 20. The main structure 10 and the support leg 20 are connected to each other by a hinged joint so that the angle formed between the two elements may vary.

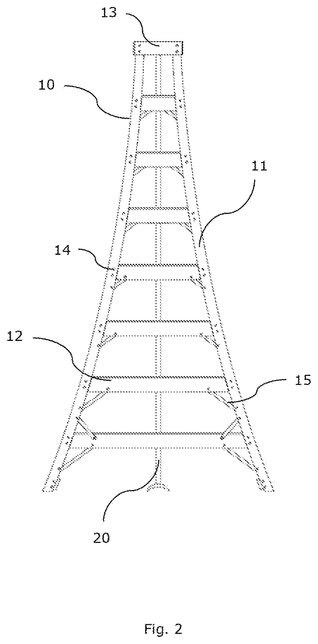

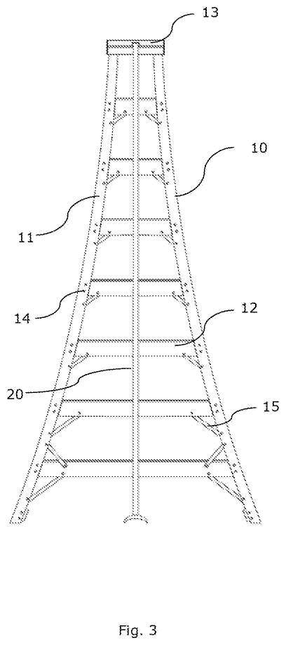

As can be seen in FIG. 2, the stringers 11 of the main structure 10 are in a vertical position, between which the rungs 12 are arranged in a horizontal position and preferably spaced equidistantly apart from each other. As can be seen in the embodiment illustrated in FIGS. 2 and 3, the beams 11 are partially curved and configured so that the convex faces of both beams are facing each other. This arrangement causes the width of the ladder to be inversely proportional to the height.

As can be seen in the figures, the stringers 11 and rungs 12 have a channel shape or straight U-shaped profile. In addition, these are joined together by rivets 14 and additionally through gussets 15 (FIGS. 2 and 3). Preferably, each rung 12 is attached to the beams by means of two pairs of gussets 15, each pair attaching the front and rear edge of the step to the front and rear edge of each beam 11, respectively. According to the illustrated embodiment, the gussets 15 are arranged inside the profile of the beams 11 and steps 12, being connected to them by rivets 13.

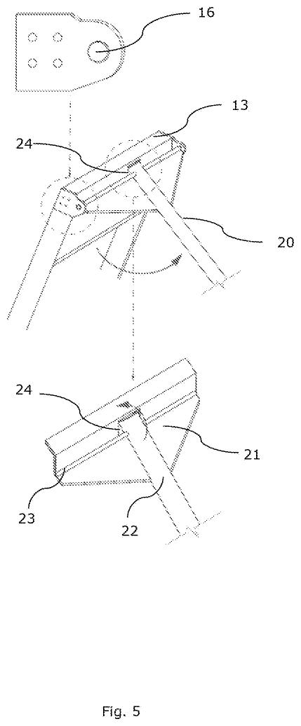

As can be seen in more detail in FIG. 5, the upper platform 13 comprises 5 faces: a horizontal upper face and 2 side faces, a rear face, and a front face that are vertical. The side faces of the upper platform 13 have a hole 16, which is configured to receive the support leg 20. To do this, the support leg 20 comprises a pair of plates 21 at its upper end, preferably welded to each side of the tube 22, which, in turn, are joined at their upper end to a horizontal cylinder pin 23 that crosses the support leg tube and whose ends are configured to receive a bolt that is inserted into each hole 16 of the upper platform 13, resulting in a swivel joint, as indicated by the arrow in FIG. 5. For its part, the rear vertical face of the platform comprises a notch or slot 24 preferably of quadrilateral shape, which is aligned with the upper end of the tube 22 and has a height such as to only allow the upper face of said tube to adopt a maximum 90° position with respect to said rear vertical face.

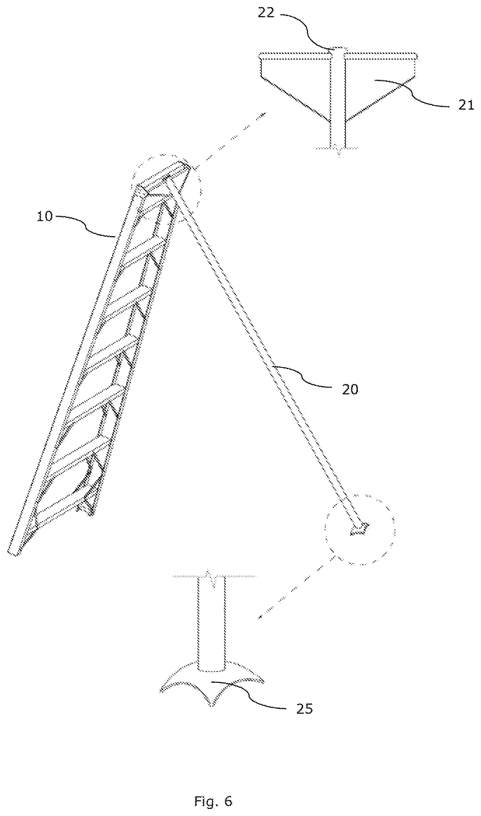

Proceeding with FIG. 6, it is shown that the plates 21 preferably have a trapezoidal shape, while at the lower end of the support leg 20 there is a gripping element 25, which has a preferably convex curved shape with at least 4 vertices or points of support with the ground. The convex curved shape of the gripping element gives a high resistance, and therefore long durability, to this element that generally works subjected to compression and bending stresses. Secondly, such a shape is suitable for providing a good grip on the ground, especially on land such as soil, mud, stones, or branches, which is where harvesting ladders are usually used.

1. A ladder for preventing unwanted accidents by means of a simplified structure and mechanism, said ladder comprising:
a main structure (10) including stringers (11), rungs (12), and an upper platform (13); and
a support leg (20) in the shape of a tube (22), pivotally connected to the upper platform (13);
CHARACTERIZED in that the upper platform comprises a top face, two side faces, a front face, and a rear face, wherein said side faces have connection means to connect to a connector of the support leg (20); and
in that the rear face has a slot (24) whose height is less than the diameter of the tube (22).

2. The ladder according to claim 1, wherein the support leg connector is a cylinder pin (23) that passes perpendicularly through the tube (22), near its upper end, wherein the ends of the pin (23) are connected to the upper platform by means of bolts.

3. The ladder according to claim 2, wherein the pin (23) is attached to a pair of welded plates on each side of the tube (22).

4. The ladder according to claim 3, wherein the support leg (20) has a gripping element (25) at its lower end.

5. The ladder according to claim 4, wherein said gripping element has two or more points of support with the ground.

6. The ladder according to claim 4, wherein the gripping element has a convex curved shape.

7. The ladder according to claim 1, CHARACTERIZED in that the connecting means consist of holes (16).

8. The ladder according to claim 1, CHARACTERIZED in that the stringers (11) are partially curved and positioned in such a way that the convex faces of both stringers (11) are facing each other.

9. The ladder according to claim 1, CHARACTERIZED in that the stringers (11) and rungs (12) are channel-shaped.

10. The ladder according to claim 1, CHARACTERIZED in that the stringers (11) and rungs (12) are joined together by rivets (14).

11. The ladder according to claim 1, CHARACTERIZED in that the stringers (11) and rungs (12) are joined together by rivets and gussets (15).
